(19) United States
(12) Patent Application Publication
(10) Pub. No.: US 2002/0078145 A1
(43) Pub. Date: Jun. 20, 2002

(54) System design for E-business and for access to sources of information, goods and services

(76) Inventor: David Beran, Mirovice-Velen (CS)

Correspondence Address: Marc S. Hanish, THELEN REID & PRIEST LLP, P.O. Box 640640, San Jose, CA, 95164, US

(21) Appl. No.: 09/938,475

(22) Filed: Aug. 23, 2001

(30) Foreign Application Priority Data
Sep. 21, 2000 (CS) PV 2000-3501

(51) Int. Cl. G06F 15/16

(52) U.S. Cl. 709/203; 709/250

(57) ABSTRACT

A specially designed system for E-Business and for access to sources (goods, services and information) is provided which is based on an enclosed network environment comprising a group of servers connected to an independent network with established and secured communication with the surroundings. This ensures that clients are properly mediated and secured access is available via the interface. The interface is the place where all internal services are provided to the Client. The system ensures transparent and safe implementation of Internet business, quick and easy acquisition of any kind of information whatsoever (data) from electronic sources without the need for special knowledge or skills (knowledge of electronic addresses, ability to control searching servers, etc.), and guarantees the observance of license agreements and protection of copyright, allows mass dissemination of the use of electronic trade by user groups who do not possess special knowledge.

### CROSS REFERENCE TO RELATED APPLICATION

This application claims priority based on Czechoslovakian Application PV 2000-3501, entitled “System Design for E-Business and for Access to Sources of Information, Goods and Services”, by David Beran, filed Sep. 21, 2000.

### FIELD OF THE INVENTION

The present invention relates to Electronic Business (“E-Business”). More particularly, the present invention relates to a system design for E-Business and for access to source of information, goods, and services.

### BACKGROUND OF THE INVENTION

Currently, the most efficient manner in which to access many types of data or services is via the Internet. In order to quickly and easily locate this data, search engines are used. Search engines are Internet web pages which allow users to type in keywords to locate data. Search engines are either independent or are part of a portal, a site providing a multitude of services such as news, directories, email, discussion groups, online shopping, etc. A drawback of search engines is that there is a low degree of efficiency in the acquisition of the desired data, mainly because search engines generally contain outdated or irrelevant links. Furthermore, user control of these systems can be difficult due to the large amount of user inconsistencies and the often complicated nature of the control.

Payment transactions conducted over the Internet are generally secured by varied application of cryptographic procedures. Additionally, “electronic valets” or electronic credits may be used, which deal with the problem of micro-payments. In the case of cross-border services, an additional problem is how to deal with the risk of a client who has, for some reason such as mistake or duplicity, been charged without justification for services never provided to him. Warranties for such services are generally granted to United States citizens on United States territory only, owing to the existence of special legislation and the action of the Federal Business Committee—an office with extensive powers that monitors, among other things, the behavior of companies running their business on Internet. No such protections are available for international transactions, however.

Another problem encountered with the transfer of data over the Internet is in the protection of legal rights. License agreements and copyrights may be infringed by the ease of large-scale copying that the Internet permits. With regard to the problem of observance of license agreements and copyrights, several systems are under preparation, but none of them is standardized and ready for everyday use. In addition, the practical usage of current systems is complicated, as they use various types of internal codes, whose incorporation into data flow is aimed at preventing misuse or the dissemination of copyrighted data. The internal codes may then be retrieved from any copy found on the Internet, proving that it was an unlawful duplication. However, these solutions fail to cover the complete range of protected types.

Electronic Business (E-business) web sites often offer users to obtain products and services in a convenient environment. However, they have a number of disadvantages. Internet-based crimes are on the rise, thus the safety of conducing business online may be an issue. Furthermore, when a consumer feels he has been wronged, the possibilities of legal redress are somewhat vague, as the warranty for the goods may not be granted directly from the web site. Uncertain terms of delivery of the ordered goods and, in general, unclear contractual relations in case of unauthorized withdrawal of money from the Client's bank account are also concerns. Sporadic upgrading to reflect the current state of science, technology or legislation can also be a problem. The quality of secondary services such as transport and assembly may also be a problem. The web site itself may be difficult to use, due to various levels of orientation with the system, inconsistent implementation, and diversity of contents. Furthermore, sites are usually in the local language or in English, rarely in other language versions. Lastly, purchase or delivery is usually restricted on a regional basis.

Internet Portals are web sites offering a variety of different services. They have at present a large number of users, and represent a high concentration of information and services. Their disadvantages often include complicated searching, language localization, inconsistent control and the provision of unauthorized information.

Portals came into being as an attempt to provide broader services related to information search engines on Internet. Most of the information searched is sorted into a limited number of categories—e.g. weather, price lists, cinema programs etc. Since their income is derived from advertisement in various forms, the goal of portals is to acquire as many clients as possible. Unfortunately, the technical resources that secure the operation of portals are usually lagging behind current needs. From the hardware point of view, these resources usually comprise a group of servers interconnected in such a way that all tasks are processed in real time, in a similar manner to a single server. For instance, Windows NT or UNIX can be used as the operation system, whereas SQL or a modification thereof usually comprises the database engine, which cooperates with tailored software ensuring effective algorithms for searching and data collection and at the same time ensuring other services provided by the portal.

The problem with portals corresponds to general problems of Internet as a whole—solutions for the same problem may be completely different. There is a tendency to be as different from competitors as possible. The result is that a client who has learned to work with one portal will have difficulties achieving as rapid and easy an orientation in another portal. Since, in general, portals are built around search engines, they are predominantly locally focused. Usually they are only in one language version, that of the local language. Examples of portals include: http://www.atlas.cz, http//www.seznam.cz, http://www.msn.com, and http://www.netscape.com.

Search engines currently have an advantage in that they concentrate large volumes of sorted data and make it available to the general public. Some of them also provide the services listed above. However, they have some disadvantages as well. For effective use, it is necessary to have a basic knowledge of searching in database systems. Additionally, the language version problem arises. Furthermore, in some cases the information obtained has low informational value. Some search engines also offer a search mode in “human language”—the question is entered in the form of ordinary sentence, which is then analyzed by the search engine's expert system, on the basis of which analysis the search is carried out. These systems usually work in English only. The success rate of these systems is based on the type of questions—the simpler the type of question, the higher the chance for correct analysis.

The technical system of search engines is similar to that of Internet portals above.

The standard in this field is set by the AltaVista (http://www.altavista.com) and Yahoo (http://www.yahoo.com) engines. They go through a certain range of WWW servers (covering about 40% of all available Internet sources) and save the key-words from the web pages into their databases. This database is then used for answers for particular user questions. This method is based on purely mathematical coincidence, and thus causes factual confusion—themes representing synonyms to the entered chain are found, too, although they may be in fact from another branch. Servers try to solve this by means of so-called search operators, the use of which increases the success rate of the search. On the other hand, they are confusing for the average user and difficult to remember.

Other possible specification involves so-called META-tags, which are incorporated into the web page (entered by the author of the web page) and which contain a list of keywords describing the contents of the web page. The assignment of such a page to another search question is thus eliminated. This system is incorporated into a small percentage of sources currently available on Internet. Unfortunately, false META-tag publication in the source texts of a web pages is no rare occurrence—the aim of this is to duplicate certain links in search indexes. This is also known as “spamming” the search engine.

AltaVista, for instance, offers translation of web pages into the language of the user. The translation is based on word-for-word translation. Web pages obtained in this way are in most cases devoid of informational value, as the translations are very poor.

The most popular search engines are:

### AltaVista

Description: A highly popular fulltext search engine with about 31 million indexed web pages

Note: Using the “Refine” option, it is possible to “tune-up” the results of a search.

### Yahoo (http://www.yahoo.com)

Description: The largest hierarchically arranged directory. From 15 basic classes, it is possible to find the searched item by means of a very fine sorting system. The system enables fulltext search as well (close cooperation with AltaVista).

### Hotbot (http://www.hotbot.com)

Description: A fulltext search engine with about 55 million indexed web pages.

### Lycos (http://www.lycos.com)

Description: A fulltext search engine. It is possible to use other services within the scope of this system, e.g. PeopleFind (search for people in the US telephone directory) or RoadMaps (finds maps of an area and optimal road routes—valid in USA only).

### Infoseek (http://www.infoseek.com)

Description: A fulltext search engine. Places emphasis on lower and upper case letters.

### BRIEF DESCRIPTION OF THE INVENTION

A specially designed system for E-Business and for access to sources (goods, services and information) is provided which is based on an enclosed network environment comprising a group of servers connected to an independent network with established and secured communication with the surroundings. This ensures that clients are properly mediated and secured access is available via the interface. The interface is the place where all internal services are provided to the Client.

The enclosed network environment comprises the servers, which are sorted into a structure in which the central server is located at the top of the enclosed network and at least one national server and operator server comprise the lower levels. The operator server is communicatively linked with clients. The interface is a user environment, and comprises the following special media: specially designed software, specially designed hardware and organizational media. Mediated access involves mediated interconnection between the client and the source, and comprises an interface security module and a client security module.

The system ensures transparent and safe implementation of Internet business, quick and easy acquisition of any kind of information whatsoever (data) from electronic sources without the need for special knowledge or skills (knowledge of electronic addresses, ability to control searching servers, etc.), guarantees the observance of license agreements and protection of copyright, and allows mass dissemination of the use of electronic trade by user groups who do not possess special knowledge.

The system also permits the possibility of rapid transfer to another standard upon the dissemination of the patented system on a mass scale owing to the central form of the system administration, allows a uniformly high degree of security and the provision of delivery term warranties and warranties of business transaction claim settlements, if applicable, provides for clear contractual relations; simple and uniform control and information searching, the provision of authorized information, and the removal of the problem of different language versions and language barriers.

The invention may also include the creation of an interface characterized by its safety and by certain elements of the expert system. The client is separated from the dangerous environment of Internet in that he communicates with an interface consisting of an enclosed network of servers, which communicate with each other and with the client at a secured level, and which simultaneously comprise an environment in which a special software prepares all services for the client, ranging from intelligent information searching to the procurement of E-Business transactions. This provides the user with the maximum comfort during information searches and E-Business procedures and minimizes the time, effort and quantity of specific information required to obtain information or to execute E-Business transactions.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a schematic diagram of all principal parts of the system in accordance with a specific embodiment of the present invention.

FIG. 2 is a schematic diagram of the system's manner of securing input and output in accordance with a specific embodiment of the present invention.

FIG. 3 is an example of user screen lay-out in accordance with a specific embodiment of the present invention.

### DETAILED DESCRIPTION

Embodiments of the present invention are described herein in the context of a system of computers, servers, communication mechanisms, and tags. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

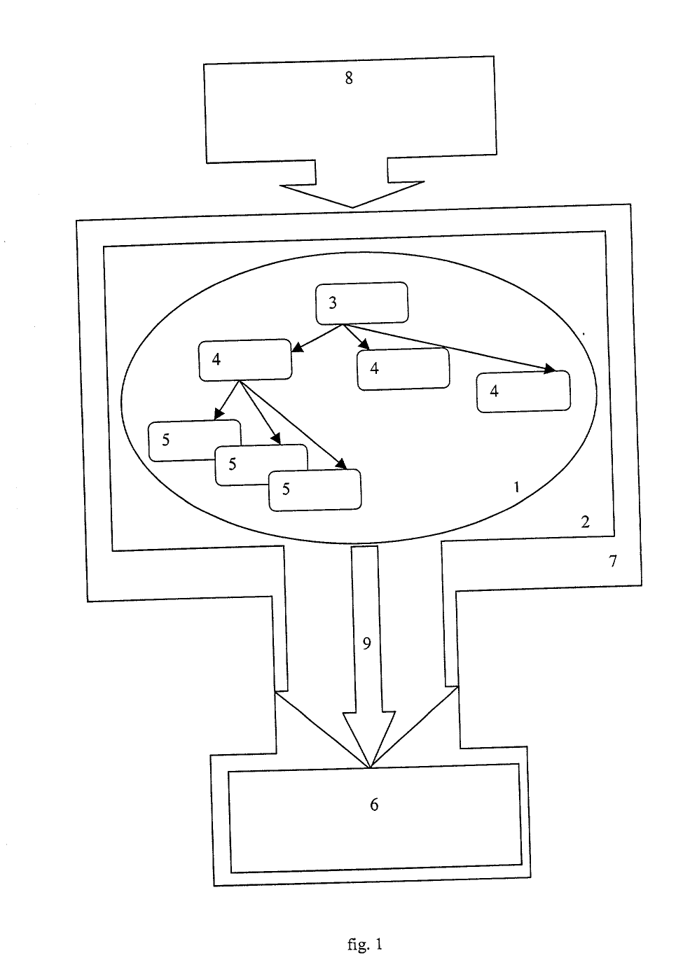

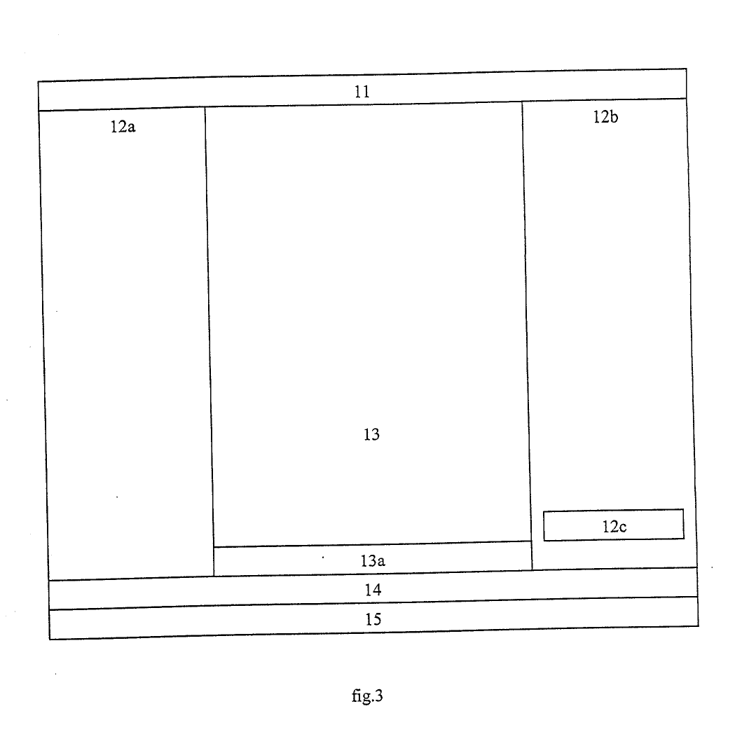

FIG. 1 is a schematic diagram of all principal parts of the system in accordance with a specific embodiment of the present invention. The system comprises at least one operator server 5 and one central server 3. There may also be at least one national server 4. Each national server 4 may have one or more operator servers 5 corresponding to it. The individual servers are interconnected in an enclosed network 1 technically implemented by means of virtual interconnections on rented lines, or by own interconnections, or by other means of communication, so as to enable only secured entry 7, both between individual servers and between operator servers 5 and clients 6. Clients 6 of the system may use a unified user interface with a precisely defined menu structure, which is arranged from the organizational point of view in a form of tree, and a simple method of control by means of number codes, as will be discussed later in reference to FIG. 3.

Each national server 4 may correspond to a different country, or at least to a different language. The operator servers 5 corresponding to each national server 4 may represent states or regions within the country. The system provides internal services 9, e.g. information pages using a unified style which are delivered by the system, either repeatedly or once upon request of the client 6, or as a standard offer of the operator server 5. These information pages are prepared in the national language of the appropriate national server 4 and in English, as is the tree of the client menu of the individual operator server 5. The trees of all operator servers 5 coming under one national server 4 are collected into a so-called global tree, which is located at the national server 4. Individual sources 8 of goods, services and information are contractually bound to one operator server owner 5, to whom they provide their sources 8 for the whole system. Contractual relations also involve the organization arrangement of Clients' 6 access to sources 8, of single operator server 5 owners' access to each another, of single operator server 5 owners' access to the data, services and functions of the national server 4 and of single operator server 5 owners' access to the services and functions of the central server 3.

The central server functions:

to keep a table of all operator servers 5 which also incorporates the number of the bank connection for payments between operators;

to enable the addition and removal of operator servers 5 to and from the system;

to ensure advertisement distribution—this can be common to all national servers 4 or different for each national server 4. The advertisements may also be different for each operator server 5;

to keep a list of all items of the global tree—this is used for transformation of the tree when the Client 6 views a tree of another operator server 5 (in another country, the tree may be arranged in a different way);

to maintain a database of keys of uninstalled Clients 6 which is provided by the operator server 5 on request;

to record the financial transactions; and

to enable the setting of parameters for financial transactions executed by the system.

The national server functions:

to keep records of all operator servers 5 which are in the relevant region;

to keep a table of all custom-made web pages;

to keep a table of all common standard web pages;

for each custom-made web page, to maintain a table of all clients 6 wanting it;

to keep a table of authorization information (for safe logging-in by users);

to keep a table of all businesses, products and prices for the relevant region;

to keep a table of all concluded agreements with sources 8—agreements are concluded by single owners of operator servers 5;

to maintain the global tree;

to transfer its tree to another operator server 5, either in the national language or in English;

to ascertain that the operator server 5 is accessible again after a connection has been cut;

to add a new operator server 5—to copy all tables and to make an entry into the table of operators at all other operator servers 5;

to remove an operator server 5—to erase an operator from the table of operators of all other operator servers 5;

to maintain and provide a national register of web pages which consists of the key words of individual web pages and which also contains the key-words of custom-made web pages, entered by robot and removed when the web page is canceled; and

to receive advertisements from the central server 3 and to distribute them to the operator servers 5.

The operator server functions:

to maintain and create web pages; to provide internal services 9 to the system of Clients 6;

to maintain and create the operator server 5 tree with the standard offer;

to list all Client 6 transactions;

to store Clients' data;

to mediate sources 8 to other operator servers 5; and

to mediate sources 8 to Clients 6 via the system interface 2 with secured access 7.

The legal relationship between an operator server 5 owner and a central server 3 owner may contain at least the following items:

1. Number of users for whom the system has been purchased;

2. Rules for concluding contracts with Clients 6;

3. Obligation of entry into a contract with a credit company;

4. Description of hardware, with which the system will operate;

5. Ensuring properly dimensioned connection between the operator server 5 and Clients 6 and the central server 3;

6. Obligation to reserve part of the hardware capacity for the operation of the national server 4;

7. Obligation to respect the rules of cash flow between the operator server 5 owner and the central server 3 owner;

8. Description of relations between operator server 5 owners in the region of the national server 4;

9. Obligation to respect the exclusivity of contracts of other operator server 5 owners with sources 8;

10. Obligation to respect the ownership of custom-made web pages by other operator servers 5;

11. Obligation to respect the rules for cash flow between individual operator server 5 owners;

12. Obligation to establish, together with the other operator server 5 owners, an institution which will be the owner of the national server 4; and

13. Obligation to contribute to the reserve fund of the above institution.

The legal relationship between an operator server 5 owner and a source 8 may contain at least the following provisions:

1. Rules for the provision of goods, services or information;

2. Obligation of the source 8 to ensure delivery of goods, service or information to Clients 6;

3. Obligation of the operator server 5 owner to record the business transactions completed;

4. Obligation of both contracting parties to respect mutual cash flows;

5. Obligation of the source to hand over to the operator server 5 owner information about the selection on offer, in an agreed form;

6. Commitment of the source 8 to exclusivity within the scope of the national server 4.

The legal relationship between an operator server 5 owner and a client 6 contains at least the following provisions:

1. Obligation of the Client 6 to regularly pay the fees for entry to the system;

2. Obligation of the Client 6 to pay for services and goods provided for a fee;

3. Obligation of the operator server 5 owner to provide the Client 6 with entry 7 into the system;

4. Obligation of the operator server 5 owner to ensure safety of executed transactions for the Client 6;

5. Agreement between the operator server 5 owner and the Client 6 on the securement of the User's payments to the credit company;

6. Obligation of the operator server 5 owner to ensure delivery of ordered goods, services or information to the Client 6.

On the User menu tree, each item may have its own hierarchic designation by number code as follows:

1. Master item 1

1.1 Slave item 1 of master item 1

1.2 Slave item 2 of master item 1

1.x Slave item x of master item 1

2. Master item 2

2.1 Slave item 1 of master item 2

2.2 Slave item 2 of master item 2

2.x Slave item x of master item 2

X. Master item x

x. 1 Slave item 1 of master item x

x. 2 Slave item 2 of master item x

x.x Slave item x of master item x

x.x.x Slave item x of slave item x of master item x where x can be 1-9 and the depth of the structure is not limited.

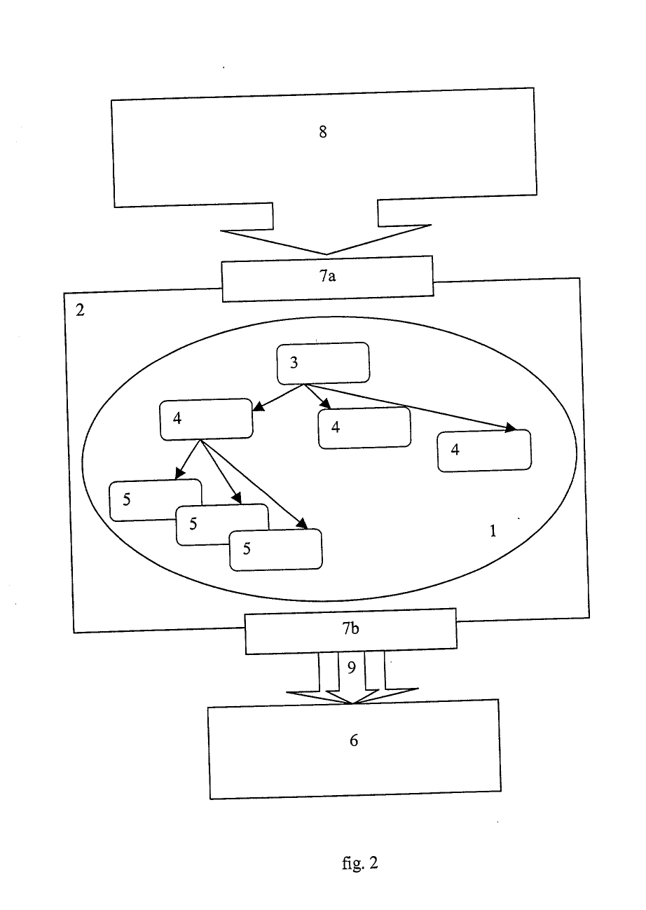

FIG. 2 depicts a security feature for making the communications between the clients and the enclosed network secure. The secured access 7 may comprise an interface 2, a security module 7a and a client security module 7b.

FIG. 3 is an example of a user screen layout in accordance with a specific embodiment of the present invention. As is clear from FIG. 3, the user screen is divided into several parts. Data concerning the appropriate national server 4 and the currently selected language version, user name of the Client 6, date and time are, for instance, displayed in the information bar 11. Display control bar 15 contains, for instance, controls for moving to the next or last page, enter and exit. The display interface control bar 14 contains, for instance, controls for displaying or returning to the main page, search page, set-up page or help. Single menu items are displayed in the 12a and 12b spaces; items displayed in 12a are one level higher than the current level, which is displayed in 12b. Selections are made from this latter level by means of a numerical code. This code exactly specifies each and every item in such a way that the code is entered into 12c. The information selected is displayed in 13 and, if further handling of the displayed information is relevant, the appropriate controls are displayed in 13a.

The application of the system using the interface 2 can be divided into individual logical parts, for instance in the following way:

Communication with Client 6 using secured entry 7;

Provision of internal services of the system 9 for the Client 6;

Part used by the operator server 5 owner for the recording and administration of the operator server 5 and of transactions;

Part ensuring mutual communication between servers 3, 4, 5 in the environment of the enclosed network 1;

Communication with sources 8 using secured entry 7.

Example of a user menu tree:

1. Entertainment

1.1. Music—provided on Internet

1.1.1. Free recordings

1.1.2. Recordings for charge

1.2. Movies—provided on Internet

1.2.1. Movies, banners, samples distributed free of charge

1.2.2. Movies for charge

1.3. TV programs on Internet

1.3.1. Internet TV broadcasting

1.3.2. Interactive TV programs

1.4. Sport

1.4.1. Latest sports results

1.4.2. Sports news coverage

1.4.3. Sporting event calendar

1.4.4. Records of sporting events records

1.4.5. Bookmakers

1.5. Live shows

1.5.1. Live sports broadcasts

1.5.1.1. Calendar of sporting events for selection (filter by branch, site, etc.)

1.5.1.2. Sports broadcasts by branch

1.5.2. Cultural events

1.5.2.1. Calendar of live cultural event broadcasts for selection (filter by branch, site, etc.)

1.5.2.2. Cultural events by branch

1.5.3. Social events

1.5.3.1. Calendar of live broadcasts of social events for selection (filter, etc.)

1.5.3.2. Live broadcasts of social events by branch

1.6. Culture

1.6.1. Movies

1.6.2. Theater

1.6.3. Visual arts

1.6.4. Music

1.6.5. Architecture and design

1.6.6. Other

1.7. Society

1.8. Serials (information on serials and broadcasting times)

1.9. Radio (list of Internet radio stations)

1.10. Games

1.10.1. Games played on Internet

1.10.2. Computer games

2. Trading

2.1. Motor vehicles and accessories

2.2. Travel, recreation, accommodation

2.3. Gifts jewelry, flowers, watches, etc.)

2.4. Domestic, utensils

2.5. Transport

2.6. Photography

2.7. Hobby, leisure time, animal breeding, collecting

2.8. Toys and entertainment

2.9. Office appliances and equipment

2.10. Books, music, videocassettes

2.11. Clothes and fashion accessories

2.12. Computers and PC components

2.13. Property

2.14. Sex shops, erotic material

2.15. Software, computer games

2.16. Sport and camping equipment, fitness

2.17. Consumer electronics

2.18. Construction material

2.19. Other goods and services

3. News

3.1. Domestic press—prestigious media

3.2. Domestic press—tabloid

3.3. Domestic information agencies

3.4. Internet news

3.5. Teletext news

3.6. TV and radio news

3.7. Foreign news

3.7.1. Foreign press—prestigious media

3.7.2. Foreign press—tabloid

3.7.3. Foreign information agencies

3.7.4. Foreign teletext services

3.7.5. Foreign Internet news

3.7.6. Foreign TV and radio news

4. Travel

4.1. Timetables

4.1.1. Airline schedules

4.1.2. Railroad schedules

4.1.3. Bus schedules

4.1.4. Combined transport

4.2. Accommodation

4.2.1. Domestic

4.2.2. Foreign

4.3. Holidays

4.3.1. Travel agencies

4.3.2. Individual holidays—domestic

4.3.3. Individual holidays—abroad

4.3.4. Special offers

4.4. Geographical information

4.4.1. Continents, areas, countries—information

4.4.2. Cities—information

4.4.3. Places—information

4.4.4. Maps

4.4.5. City plans

4.5. Information for drivers

4.5.1. Traffic regulations

4.5.2. Information for journeys abroad

4.5.3. Road conditions

4.5.4. Border crossings, ferries

4.5.5. Route search

4.5.6. Car hire offices

4.6. Legal information for journeys and sojourns

4.6.1. Travel formalities

4.6.2. Health requirements (vaccination, etc.)

4.6.3. Veterinary rules for travel

4.6.4. Special local legal regulations

4.6.5. Calendar of holidays

5. Information

5.1. Weather—home

5.2. Weather—abroad

5.3. Calendars and surveys of important events (this will also contain information about live broadcasts)

5.3.1. Calendar of important events—politics, economics

5.3.2. Calendar of important events—culture and society

5.3.3. Calendar of important events—sport

5.4. Local information

5.4.1. Offices

5.4.1.1. Ministries

5.4.1.2. Civil Service offices

5.4.1.3. Local authorities

5.4.1.4. Revenue Authorities

5.4.1.5. Trade Offices

5.4.1.6. Land Registers

5.4.2. PTT information

5.4.3. Banks and other necessary institutions

5.4.4. Telephone directories

5.5. Company information

5.5.1. Register of Companies

5.5.2. Trade Register

5.5.3. Corporate information databanks

5.6. Geographical information

5.6.1. Maps

5.6.2. Information on countries

5.6.3. Information on localities

5.7. Legal information

5.7.1. Civil Law

5.7.2. Commercial and Trade Laws

5.7.3. Tax Laws

5.8. General information by entry (choose from register and further specification of the term)

6. Finance

6.1. Bank (contact with Client's Bank)

6.2. Bank information (prices and offer of banking services)

6.3. Exchange rates

6.3.1. Foreign currencies

6.3.2. Securities trading

6.3.3. Commodity exchanges

6.4. Investment (prices and offer of services)

6.5. On-line investor (special service of the system)

6.6. Credits—offers

6.6.1. Leasing

6.6.2. Hire-purchase system

6.6.3. Cash

6.7. Current account control (automatic inspection of electronic account statements for credit card transactions)

7. Services

7.1. Maintenance and repairs

7.1.1. Car repairs

7.1.2. Repairs—property

7.1.3. Repairs—equipment and furnishing

7.1.4. Repairs—electrical appliances

7.1.5. Repairs—bicycles and sports equipment

7.1.6. Other repairs

7.1.7. Cleaning services

7.2. Home shopping services

7.3. Baby-sitting

7.4. Parcel services, mailing services

7.4.1. PTT information

7.4.2. Domestic services

7.4.3. International services

7.4.4. Courier services

7.5. Culture

7.5.1. Cinema

7.5.2. Theater

7.5.3. Social events

7.6. Sport

7.6.1. Sporting events

7.6.2. Sports facilities

7.7. Entertainment

7.7.1. Restaurants

7.7.2. Bars

7.7.3. Discotheques

7.7.4. Erotica

7.8. Education

7.8.1. Full-time study

7.8.2. Part-time study

7.8.3. Special courses

7.8.3.1. Language courses

7.8.4. Correspondence courses

7.8.5. Foreign educational visits

7.8.6. Study by Internet

7.9. Legal services

7.9.1. Legal advice

7.9.2. Contact with attorney

7.9.3. Notarial services

7.9.4. Court information

7.10. Insurance services

7.10.1. Personal life insurance

7.10.2. Property insurance

7.10.3. Travel insurance

7.11. Property administration services

7.11.1. Tax services

7.11.2. Finance administration services

7.11.3. Property administration services

8. Health

8.1. Electronic doctor

8.2. Psychology

8.3. Monitoring of Client health monitoring (including installation of home devices)

8.4. Encyclopedia of medicine

8.5. Contact to doctor

9. Advertisement

9.1. Personal

9.2. Sale and purchase

9.2.1. Motor vehicles

9.2.2. Property

9.2.3. Sports equipment

9.2.4. Animals

9.2.5. Furniture and domestic appliances

9.2.6. Machines and equipment

9.2.7. Others

9.3 Offers and requirements

9.3.1. Employment

9.3.2. Services

As is clear from FIG. 3, the user screen may be divided into several parts. Data concerning the appropriate national server 4 and the currently selected language version, user name of the Client 6, date and time are, for instance, displayed in the information bar 11. The display control bar 15 contains, for instance, controls for moving to the next or last page, enter and exit. The display interface control bar 14 contains, for instance, controls for displaying or returning to the main page, search page, set-up page or help. Single menu items are displayed in the 12a and 12b spaces; items displayed in 12a are one level higher than the current level, which is displayed in 12b. Selections are made from this latter level by means of a numerical code. This code exactly specifies each and every item in such a way that the code is entered into 12c. The information selected is displayed in 13 and, if further handling of the displayed information is relevant, the appropriate controls are displayed in 13a.

The Client 6 uses the operating screen of the user interface for access to the defined entities of the system. From the operational point of view it is divided into several parts, as is clear from FIG. 3.

The selected information 13 display area contains:

Operational information

Hot Tips

Postal service information

Information on state of internal account

The display interface 14 control bar may have the following controls:

01. Home page

02. Go to registry

03. Go to archive pages

04. Go to settings

09. Start standard explorer

099. Help

The information bar with regional data 11 may contain:

A date and time field

Information on the national environment, current server, user group and user.

For an example of single menu entity types, see the sample tree described above.

As far as the index/search screen, the register is displayed in the selected information 13 display field. Either the keywords are displayed in alphabetical order, starting with A, or the leaves of the tree are displayed in numerical order (1.1.1.1. . . . 9.9.9.9). It is possible to switch between the above display modes by means of the 022 Pages/Index controller, which is on the selected information handling bar. Upon selection of a letter (by pressing a button or by selection as on a mobile phone) or number, the cursor moves to the requested initial letter of a word, or leaf of a tree. By making other letter choices, the user chooses fritter letters of the word in the register. The choice is terminated by pressing OK on the display control bar 15. 023 Global Index controller on the selected information handling bar 13a is used to select a tree of another operator server 5 or an index of other national server 4. After selection, a choice is made from among the national flags, which represent the national servers 4. In order to select a state or region, a list of operator servers 5 of the chosen national server 4 is displayed. If an operator server 5 is not selected, the index of the selected national server 4 is displayed. Otherwise, the menu tree of the chosen operator server 5 is displayed. The choice is terminated by clicking OK. By clicking on 021 New User Page on the selected information handling bar 13a, one can change the contents of the selected information display field 13, where a form is displaying for entering a request to create an information page.

For cash flows within the system, upon entry, each Client 6 is allocated an internal account through which all payments pass. To make the internal operations easier and more transparent, this applies to everyone—including sources 8 and operator server 5 owners. A basic amount is credited to this account from the credit account of the Client 6. This sum is based on the contract concluded by and between the Client 6 and the operator server 5 owner. All paid operations are colored red from this internal account. Communication with a credit company (or bank) starts either if there is almost no money in the internal account (the bottom threshold is set by the operator server 5 owner), or in the case of a regular accounting period. The possibility and the value of an overdraft is set by the operator server 5 owner. If a Client 6 wishes to buy a product of the source 8 but does not have sufficient funds in his account, there are two possibilities:

1. The operator server 5 owner can allow a VEP Client 6 to overdraw on the system's internal account, in which case he himself assumes all responsibility for the settlement of payments.

2. The Client 6 will be offered the option of transferring sufficient funds from his credit company to his internal account, and the order will be implemented after the settlement of payments. The communication interface with the Credit Company is based on international ABO forms and on authorization of all payment orders via digital signatures.

Examples of questions include:

System:

1. “Is it possible to pay USD xxx?”—question whether there are sufficient funds in the bank account. The return value is YES/NO.

2. “Send USD xxx to bank account yyy for transaction zzz”—this intra-system payment order follows if the return value of 1. 1 is YES.

### Client 6

1. “Display balance of bank account”—order to display the current account balance.

2. “Display bank account history”—order to display all transactions of this account for a certain period.

The internal account is part of the personal database of a Client 6 and is recorded with the operator server 5 owner.

Electronic mail services have the properties customary for similar services which are used for standard provision of electronic mail services on Internet.

### Telephone

The operator server 5 performs the following tasks:

Finding the EP address of the Client 6

This is done by standard procedures in the same manner as searching for electronic mail addresses of Clients 6.

Establishment of connection between Clients 6.

Finding the operator server 5 to which the required Client 6 is connected, and sending the “Ring” request.

The receiving operator server 5 will “ring”.

If the required Client 6 is on-line, the operator server 5 will send information on the possibility of connection.

If the required Client 6 is off-line, the operator server 5 will make a number of redials, depending on the pre-set strategy, and if this fails it will send a message that connection is not possible.

The transmitting operator server 5 passes the message on connection possibility on to the Client 6. Client 6 establishes the connection directly.

The call is then entered into archive databases.

Periodic creation of new web pages may also be accomplished. These web pages can be created either on the basis of a request from the Client 6 or at the instigation of the operator server 5 owner. The appearance of these web pages is unified, they do not contain any unnecessary information and thus they are transferred much more rapidly. In the creation of these web pages, the source information is obtained either for a charge, on the basis of an agreement with source 8, or for free from free sources 8. It is necessary to stipulate the definition of each such web page created, in which the information to be incorporated must be specified. At the same time, it is necessary to state the period of web page updating (or a time schedule of the creation of the web page) as well as its expiration date. Two types of requests are distinguished in the creation of a new web page. The first type is a request from a Client 6 to find a single item of information (e.g. Paris theater program). The second possibility is periodic creation of web pages (repeated selections or research of information from source web pages). After processing, the result of a single question is immediately submitted to the Client 6 and this page is no longer updated. If the Client 6 wishes to have a web page which is automatically updated, the system first offers him a certain group of similar pages, which is already being made at the request of other Clients 6. If a page suits his requirements, it is automatically incorporated into his menu. Otherwise, a completely new page is created at his request. This page is submitted to him for approval and is then automatically updated. Source pages are validated, their availability is checked and a check is made of whether their structure has changed substantially.

Information pages may be translated into different languages either at the request of a Client 6 or on the basis of a decision by the operator server 5 owner. The operator server 5 owner may also prepare some general information pages in English, which are then used as a basis for translation into a third language of the national server 4, by means of which the information page is requested by another operator server 5 owner or by a Client 6.

The use of the proposed system of Client access to data and E-Business will guarantee suppliers of services and goods by E-Business an increased turnover, owing to the larger number of clients who will use the proposed system owing to its simplicity, safety and the warranties provided for suppliers and for Clients.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A system of network devices for electronic business and access to sources comprising:
one or more clients;
an enclosed network having a central server, at least one national server, and at least one operator server, said central server located at the top of said enclosed network, each of said at least one national server coupled to said central server and representing a country or language, each of said at least one operator server coupled to one of said at least one national server and representing a region or state within said country or language, said one or more clients coupled to said enclosed network through said at least one operator server; and
a user interface coupled to said one or more clients between said one or more clients and said enclosed network such that all internal services provided to the client are provided via said user interface.

2. The system of claim 1, wherein said user interface is a user environment and is created by special means.

3. The system of claim 2, wherein said special means comprise:
software design;
hardware design; and
organizational means.

4. The system of claim 1, wherein said coupling between said one or more clients and said enclosed networks is a mediated connection.

5. The system of claim 2, wherein said coupling between said one or more clients and said enclosed networks is a mediated connection.

6. The system of claim 3, wherein said coupling between said one or more clients and said enclosed networks is a mediated connection.

7. The system of claim 1, wherein said coupling between said one or more clients and said enclosed networks is secure via a software layer having an interface, a security module, and a client security module.

8. The system of claim 2, wherein said coupling between said one or more clients and said enclosed networks is secure via a software layer having an interface, a security module, and a client security module.

9. The system of claim 3, wherein said coupling between said one or more clients and said enclosed networks is secure via a software layer having an interface, a security module, and a client security module.

10. The system of claim 4, wherein said coupling between said one or more clients and said enclosed networks is secure via a software layer having an interface, a security module, and a client security module.

11. The system of claim 5, wherein said coupling between said one or more clients and said enclosed networks is secure via a software layer having an interface, a security module, and a client security module.

12. The system of claim 6, wherein said coupling between said one or more clients and said enclosed networks is secure via a software layer having an interface, a security module, and a client security module.
